(19) United States
(12) Patent Application Publication
(10) Pub. No.: US 2005/0216281 A1
(43) Pub. Date: Sep. 29, 2005

(54) System and method for managing flight information

(76) Inventor: Francis John Prior, Flitwick (GB)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/806,971

(22) Filed: Mar. 23, 2004

(51) Int. Cl. G06F 17/60

(52) U.S. Cl. 705/1; 705/9

(57) ABSTRACT

A flight information system including a collection system and a distribution system. The collection system includes a collector for receiving flight information messages in a plurality of formats, and translator for converting flight information messages in the plurality of formats received by the data collector into flight information in a common format. The distribution system is for selectively sending converted flight information to a customer as a mobile message.

### CROSS REFERENCE TO RELATED APPLICATIONS

This patent application is related to U.S. patent application Ser. No. 10/624,054 filed Jul. 21, 2003, which claims priority to U.S. Provisional Patent Application Ser. No. 60/398,024, filed on Jul. 23, 2002, both of which are incorporated herein by reference.

### FIELD OF THE INVENTION

The present invention generally relates to a system and method for managing flight information, and more particularly, to a system and method for receiving and distributing flight information.

### BACKGROUND OF THE INVENTION

Each year millions of travelers utilize the airline industry to reach their desired destinations. Many of these travelers and individuals or companies attempting to meet or pick up the travelers are frustrated by flight delays, gate changes, and other unforeseen aberrations to their original flight plan caused by severe weather, aircraft maintenance, runway closures, customer service issues, air traffic control decisions, equipment failure, etc. The frustrations of travelers and individuals or companies attempting to meet or pick up the travelers are increased by the inaccessibility of much of the delay information prior to travelers arrival at the airport in expectation of a timely departure.

Flight status messages are created by an airline every time the status of a flight changes. The status of a flight may change due to delays, cancellations, or to predict the actual flight arrival, terminal/gate and baggage claim information, etc. In order to access that information, a customer typically must either telephone the airline directly or through a travel agent, be physically present at the airline terminal and request the information from a customer service representative, or view the information via a flight arrival/departure display terminal within the airport. The majority of passengers do not check their flight status until they get to the airport in expectation of a timely departure. Therefore, passengers learning of a flight delay or cancellation upon arrival are often forced to wait at the airport for long periods of time. The long period of waiting or layover within an airport is often cited as the leading complaint against the airline industry.

Existing flight information distributors are limited to flight channels or flight numbers covered by a particular global distribution system (GDS) with which the flight information distributor is associated. In particular, each GDS offers flight information on a limited number of flights from a limited number of airlines. As such, a single GDS does not provide information to cover a relatively large cross-section of airline flights. Furthermore, information from multiple GDSs or non-affiliated airlines is typically sent in various formats and, therefore, is not typically aggregated into a single distributor system.

In addition, typical distributed flight information passes from an airlines to a GDS, from the GDS to a flight information distributor which passes the information on to a travel agent, travel website, or customer. The long chain of information providers produces multiple filters which increase the chance of error or miscommunication of flight information. Moreover, distributor dependency upon a long chain of information providers limits the flexibility with which a distributor can pass on flight information to additional parties.

### SUMMARY OF THE INVENTION

In one embodiment, the present invention provides a flight information system including a collection system and a distribution system. The collection system includes a collector for receiving flight information messages in a plurality of formats and a translator for converting flight information messages in the plurality of formats received by the data collector into flight information in a common format. The distribution system is for selectively sending converted flight information to a customer as a mobile message.

### BRIEF DESCRIPTION OF THE DRAWINGS

FIG. 1 is a block diagram illustrating one exemplary embodiment of a flight information management system including connection to a plurality of suppliers and a plurality of customers.

FIG. 2 is a block diagram illustrating one exemplary embodiment of the flight information management system, the plurality of suppliers, and the plurality of customers shown in FIG. 1.

FIG. 3 is a block diagram illustrating one exemplary embodiment of the flight information management system shown in FIG. 1.

FIG. 4 is a block diagram illustrating one exemplary embodiment of a collection system of the flight information management system shown in FIG. 3.

FIG. 5 is a block diagram illustrating one exemplary embodiment of a distribution system of the flight information management system shown in FIG. 3.

FIG. 6 is a diagram illustrating one exemplary embodiment of a portion of a customer interface to a customer profile of the collection system of FIG. 4.

FIG. 7 is a diagram illustrating one exemplary embodiment of a portion of a customer interface to specify global customer request specifications within the customer profile of the collection system of FIG. 4.

FIG. 8 is a diagram illustrating one exemplary embodiment of a portion of a customer interface to specify specific customer request specifications within the customer profile of the collection system of FIG. 4.

FIG. 9 is a flow chart illustrating one exemplary embodiment of a method of managing flight information.

FIG. 10 is a flow chart illustrating one exemplary embodiment of collecting flight information according to the method of managing flight information of FIG. 9.

FIG. 11 is a flow chart illustrating one exemplary embodiment of a pulling flight information in accordance with collecting flight information as illustrated in FIG. 10.

FIG. 12 is a flow chart illustrating one exemplary embodiment of authenticating flight information in accordance with collecting flight information as illustrated in FIG. 10.

FIG. 13 is a flow chart illustrating one exemplary embodiment of a validating flight information in accordance with collecting flight information as illustrated in FIG. 10.

FIG. 14 is a flow chart illustrating one exemplary embodiment of validating the syntax of flight information in accordance with validating flight information as illustrated in FIG. 13.

FIG. 15 is a flow chart illustrating one exemplary embodiment of validating the content of flight information in accordance with validating flight information as illustrated in FIG. 13.

FIG. 16 is a flow chart illustrating one exemplary embodiment of translating flight information in accordance with collecting flight information as illustrated in FIG. 10.

FIG. 17 is a flow chart illustrating one exemplary embodiment of storing flight information in accordance with collecting flight information as illustrated in FIG. 10.

FIG. 18 is a flow chart illustrating one exemplary embodiment of tracking transactions and errors in accordance with collecting flight information as illustrated in FIG. 10.

FIG. 19 is a flow chart illustrating one exemplary embodiment of distributing flight information according to the method of managing flight information of FIG. 9.

FIG. 20 is a flow chart illustrating one exemplary embodiment of a general request servicing process utilizing a flight information management system.

### DETAILED DESCRIPTION OF THE PREFERRED EMBODIMENTS

In the following detailed description of the preferred embodiments, reference is made to the accompanying drawings, which form a part hereof and show, by way of illustration, specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

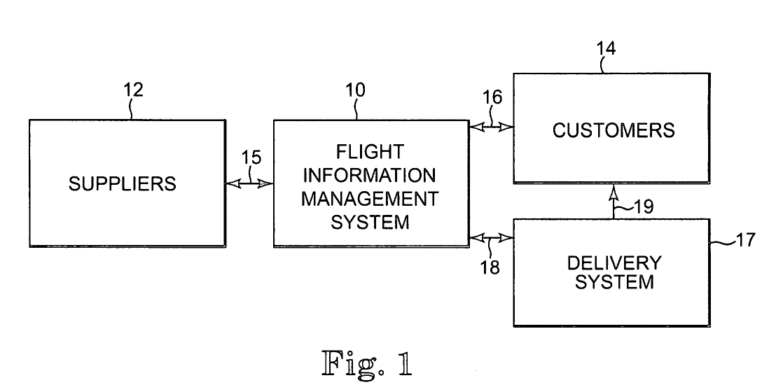

One exemplary embodiment of a flight information management system (FIMS) according to the present invention is illustrated generally at 10 in FIG. 1. FIMS 10 facilitates collection of flight information from a plurality of suppliers 12, normalizes the flight information, and distributes the normalized flight information to a plurality of customers 14 based upon general standing or individual particularized inquiries communicated to FIMS 10 by each of the plurality of customers 14. Each of the plurality of suppliers 12 is connected to FIMS 10 via a network communication link 15. Similarly, each of the plurality of customers 14 is connected to FIMS 10 via a network communication link 16.

Network communication links 15 and 16, as used herein, are each defined to include an internet communication link, such as an Internet communication link, an intranet communication link, or a similar high-speed communication link. In one embodiment, network communication link 15 and/or 16 includes at least one of Society Internationale de Telecommunication Aeronautic (SITA), Aeronautical Radio, Inc. (ARINC), Virtual Private Network (VPN), or other public or private network communication link. SITA is the preferred network for sending messages by the airline industry, and ARINC is the network of a non-profit corporation owned by member airlines to define form, fit and function of avionics equipment. In one embodiment, network communication link 15 and/or 16 includes a wireless communication link. In one embodiment, each of the plurality of suppliers 12 and/or each of the plurality of customers 14 are connected via different embodiments of network communication links 15 and 16. In one embodiment, network communication links 15 and 16 provide a connection with an appropriate level of integrity to generally prevent one other than the authorized users from manipulating the data being sent.

In one embodiment, FIMS 10 is additionally connected with customers 14 via a delivery system 17. Delivery system 17 is a network service provider and is capable of receiving messages from FIMS 10 in one format and delivering the messages to customer 14 in another format. FIMS 10 is coupled to delivery system 17 via a communication link 18 similar to communication links 15 and 16. Delivery system 17 is coupled to customers 14 via communication link 19. In one embodiment, communication link 19 is a wireless network or a plurality of wireless networks. In one embodiment, communication link 19 includes a plurality of wireless networks controlled by various wireless service providers (not shown). As such, delivery system 17 can forward messages to customer 14 by selecting the wireless network connection leading to customer 14 within communication link 19. In an alternative embodiment (not shown) delivery system 17 is included within FIMS 10.

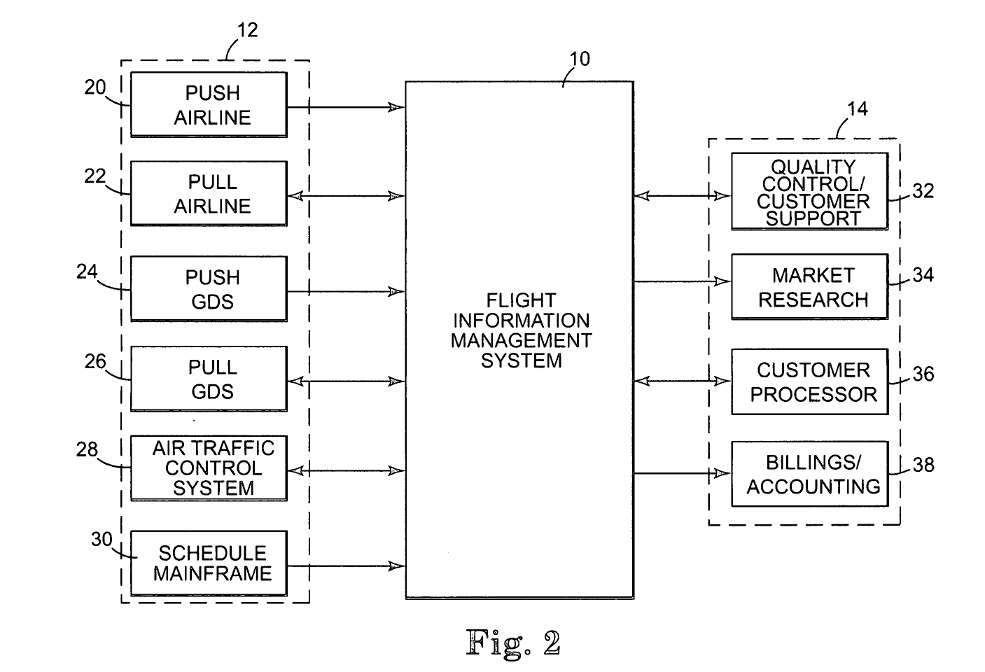

As illustrated in FIG. 2, the plurality of suppliers 12 may include one or more of a push airline 20, a pull airline 22, a push global distribution system (GDS) 24, a pull global distribution system (GDS) 26, an air traffic control system 26, and a schedule mainframe 30. Both push airline 20 and pull airline 22 are connected to and communicate with FIMS 10 to provide real-time updates of flight information directly from the airline 20 or 22 to FIMS 10 via network communication link 15. In one embodiment, push airline 20 automatically generates a flight information message and sends the message to FIMS 10 on a continuous, a periodic, or a per change basis. Pull airline 22 is queried by FIMS 10 regarding the flight information for each of the plurality of flights scheduled for the particular pull airline 22. Upon query by FIMS 10, pull airline 22 responds by generating a flight information message containing the requested flight information and sending the message to FIMS 10.

Push GDS 24 and pull GDS 26 are both systems with access to an airline or an intermediary organization reservation system, which typically includes schedules, pricing, and fare information. Push GDS 24 and pull GDS 26 each accesses flight information for either a single airline or a plurality of airlines. In one embodiment, there is an overlap of airline coverage between multiple GDSs 24 and/or 26. Push GDS 24 and pull GDS 26 typically establish connectivity between the airline or airlines the GDS has access to and travel agents. Traditionally, GDSs 24 and 26 own or store very little data other than actual flight reservations.

Both push GDS 24 and pull GDS 26 provide flight information directly from the airlines or from intermediary organizations to FIMS 10, a travel agent, or other third party. In one embodiment, push GDS 24 automatically provides flight information messages to FIMS 10 on either a continuous, a periodic, or a per change basis. Pull GDS 26 is configured to provide flight information messages to FIMS 10 following a query from FIMS 10 requesting the flight information regarding a particular flight for which pull GDS 26 has information. In particular, upon query by FIMS 10, pull GDS 26 is configured to provide the flight information requested to FIMS 10.

Air traffic control system 26 is a system capable of tracking “wheels up, wheels down” flight information, information regarding flight status from take off to landing. In one embodiment, air traffic control system 26 is the Federal Aviation Administration (FAA). In one embodiment, flight information tracked by air traffic control system 26 includes information regarding plane position, speed, altitude, etc. Air traffic control system 26 is configured to provide the specific “wheels up, wheels down” flight information messages to FIMS 10 over network communication link 15, via either a push or pull system as described above with respect to push and pull airlines 20 and 22.

In one embodiment, FIMS 10 receives flight information from schedule mainframe 30. Schedule mainframe 30 typically includes aggregated schedule information for a plurality of airlines. In one embodiment, Official Airlines Guide (OAG) operates schedule mainframe 30. In one embodiment, schedule mainframe 30 provides flight information messages to FIMS 10 via either a push or pull system, as described above with respect to push airlines 20 and pull airlines 22, respectively. Notice that schedule mainframe 30 can be any schedule data storage system or device.

Notably, the plurality of suppliers 12 may include one or more of each of push airline 20, pull airlines 22, push GDS 24, pull GDS 26, air traffic control system 26, and schedule data mainframe 30. In one embodiment, FIMS 10 receives flight information messages from a plurality of suppliers 12 and compares all flight information received, thereby, verifying the flight information received from each of the plurality of suppliers 12.

Moreover, flight information messages collected from the plurality of suppliers 12 may include, among other items, arrival and departure status information for every leg within a scheduled flight itinerary; a baggage claim, a terminal, and a gate for every leg within a scheduled flight itinerary; an operating carrier for a flight; and a delay code, if any. In one embodiment, flight information sent from the plurality of suppliers 12 to FIMS 10 is sent in one or more of the following formats: XML (eXtensible Mark up Language), API, or other format acceptable by FIMS 10. Furthermore, flight information may be exchanged via one of a variety of protocols, such as FTP (Flight Transfer Protocol) or HTTP (Hyper Text Transfer Protocol).

FIMS 10 receives the flight information from the plurality of suppliers 12, normalizes the information into a single format, organizes the information discarding duplicate flight information, and stores the remaining flight information in FIMS 10. In one embodiment, FIMS 10 tracks all transactions between the plurality of suppliers 12 and FIMS 10. Moreover, FIMS 10 is capable of sending flight information and transaction information to a portion of the plurality of customers 14 via similar networks, in similar formats, and with similar protocols as described with respect to the receipt of flight information messages from plurality of suppliers 12.

In one embodiment, flight information messages are sent as an e-mail or a mobile message. Mobile messages include text messages, Short Message Service (SMS) messages, Enhanced Message Service (EMS) messages, Multimedia Message Service (MMS) messages, or similar messages. With this in mind, customer 14 may include a computer; a wireless mobile device, such as a mobile telephone, a personal digital assistant (PDA), a pager, a beeper, a wireless handheld device (e.g. BlackBerry® device or XDA device), etc.; and/or other electronic device to facilitate making requests or receiving flight information messages in the form of e-mail or mobile messages from FIMS 10.

Each of the plurality of customers 14 receives information based upon flight information requests. Request for information by each of the plurality of customers 14 may be made on at least one of a subscription or standing basis, i.e. flight information of flights meeting that criteria set forth by each of the plurality of customers 14, or via specific request inquiries. In one embodiment, requests may be made by e-mail or mobile message. Each of the plurality of customers 14, therefore, receives information tailored to their projected use of the information. It should be noted that although illustrated as separate components, in one embodiment, one or more of the plurality of customers is included within FIMS 10.

In one embodiment, the plurality of customers 14 includes one or more of each of the following: a quality control or customer support system 32, a market research system 34, a customer processor 36, and/or a billings or accounting system 38. Quality control system 32, market research system 34, and accounting system 38 receive flight information from FIMS 10 and analyze the flight information to produce a compound or complex end product. Quality control system 32 monitors FIMS 10 to ensure FIMS 10 is working properly. Market research system 34 pools data to determine relevant statistics such as on time percentage per airline, per airport, per leg, etc. Accounting system 38 aggregates transactions for each customer to determine customer billing for use of FIMS 10.

Customer processor 36 is a processor of one of a variety of parties with a need or interest in the flight information of a variety of flights or a single flight. In one embodiment, customer processor 36 includes the processor of one or more of the following parties: the traveler or end user, airport authorities, airlines, government bodies such as the Department of Transportation (DOT) or Civil Aviation Authority (CAA), passenger organizations, third party data sales, retailers, travel agents on or off line, limousine companies, airline parking authority, hotels, rental car agencies, etc. In one embodiment, FIMS 10 sends flight information to a plurality of customer processors 36. In one embodiment, customer processors 36 are incorporated in an electronic device, such as a computer, a mobile phone, a PDA, etc. accessible by customer 14. In one embodiment, each of the plurality of customers 14 are business entities.

Notably, components of the present invention can be implemented in hardware via a microprocessor, programmable logic, or state machine, in firmware, or in software with a given device. In one aspect, at least a portion of the software programming is web-based and written in HTML and JAVA programming languages, including links to user interfaces for data collection, such as a Windows based operating system, and each of the main components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may also reside in software on one or more computer-readable mediums. The term “computer-readable medium” as used herein is defined to include any kind of memory, volatile or non-volatile, such as floppy disks, hard disks, CD-ROMs, flash memory, read-only memory (ROM), and random excess memory (RAM).

Flight Information Management System

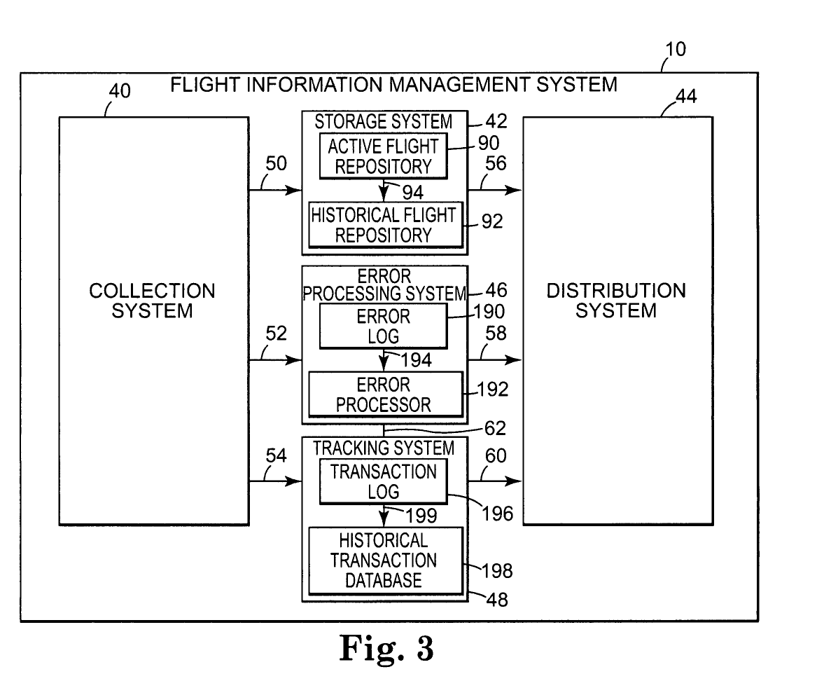

One exemplary embodiment of FIMS 10 is illustrated in FIG. 3. FIMS 10 includes a collection system 40, a storage system 42, a distribution system 44, an error processing system 46, and a tracking system 48. Collection system 40 is coupled to storage system 42 via communication link 50, to error processing system 46 via communication link 52, and to tracking system 48 via communication link 54. Distribution system 44 is coupled to storage system 42 via communication link 56, to error processing system 46 via communication link 58, and to tracking system 48 via communication link 60. Error processing system 46 is coupled to tracking system 48 via communication link 62.

Collection system 40 interacts with the plurality of suppliers 12 (shown in FIG. 2) to collect flight information messages, to translate the flight information into a common format, and to send the translated flight information to storage system 42. Storage system 42 stores the flight information, disseminated from the flight information messages, for access by distribution system 44. Distribution system 44 retrieves a portion of the flight information from storage system 42 as requested by each of the plurality of customers 14 (shown in FIG. 2), generates a flight notification file for each of the plurality of customers 14, and sends the flight notification file to the corresponding customer 14.

In one embodiment, collection system 40 and distribution system 44 track all errors and report each error to error processing system 46. Error processing system 46 receives error reports and generally attempts to prevent similar future errors. In one embodiment, collection system 40 and distribution system 44 each record transactions with the plurality of suppliers 12 and the plurality of customers 14, respectively, and send the record of each transaction to tracking system 48, which temporarily stores the records. In one embodiment, the transaction records are sent to or retrieved by one or more of the plurality of customers 14.

Collection System

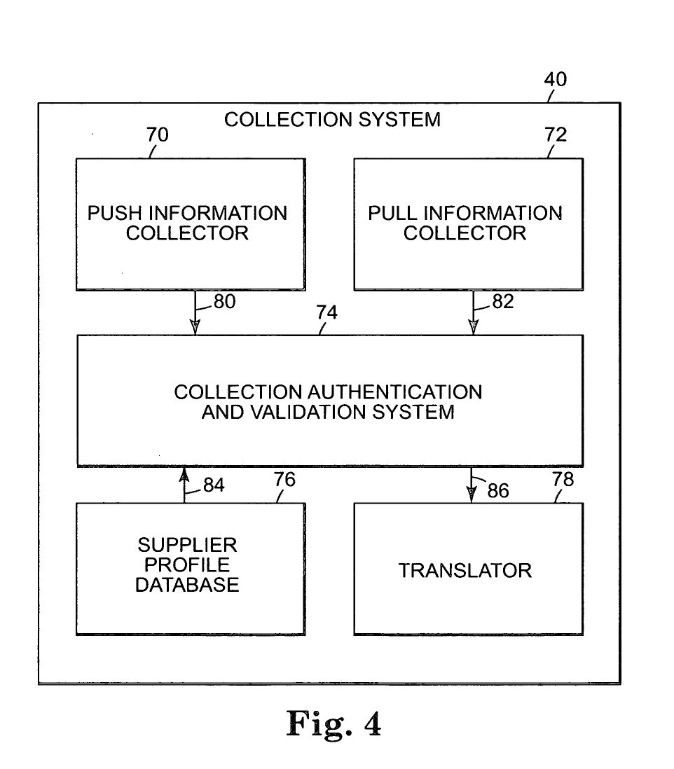

As illustrated in FIG. 4, one embodiment of collection system 40 includes a push collection system 70, a pull collection system 72, a collection authentication and validation system 74, a supplier profile database 76, and a translator 78. Push and pull collection systems 70 and 72 are each coupled to authentication and validation system 74 via communication links 80 and 82, respectively. Authentication and validation system 74 is coupled to supplier profile database 76 via communication link 84, and to translator 78 via communication link 86.

Push collection system 70 and pull collection system 72 receive flight information messages from the plurality of suppliers 12 (FIGS. 1 and 2). The messages pass from collection systems 70 and 72 to collection authentication and validation system 74, which verifies that each of the plurality of suppliers 12 is active and sends the messages in a valid format by comparing the messages received to the information stored in supplier profile database 76. Translator 78 receives the flight information message from authentication and validation system 74 in a variety of formats and translates the messages into one common format for storage in storage system 42.

Push collection system 70 receives one-way communication with a portion of the plurality of suppliers 12 that pushes flight information messages to FIMS 10. In one embodiment, push collection system 70 receives flight information messages from at least one of push airlines 20, push GDS 24, air traffic control system 26, and schedule mainframe 30 via network communication link 15 (shown in FIG. 2). As such, push collection system 70 receives the flight information on at least one of a continuous, a periodic, or a per change basis dependent upon how each of the respective plurality of suppliers 12 is adapted to provide the flight information messages to FIMS 10.

In one embodiment, the push suppliers capable of sending flight information messages on a continuous basis, more particularly, send flight information each time the flight information is updated in an internal database of the particular supplier 12. The flight information messages provided on a periodic basis are sent to push collection system 70 by a supplier capable of sending flight information messages at the end of each of a plurality of successive time periods, the length of each of the time periods being specified for the particular supplier in the corresponding supplier profile in supplier profile database 76. Flight information messages provided on a per change basis are sent to push collection system 70 by a supplier capable of sending flight information messages when a portion of the flight information is new or has changed since previous transmissions of flight information messages to push collection system 70.

Pull collection system 72 not only receives but, more particularly, retrieves flight information messages from each of the plurality of suppliers 12 that capable of providing flight information on a pull basis. In one embodiment, pull collection system 72 retrieves flight information messages from at least one of pull airlines 22, pull GDS 26, air traffic control system 26, and schedule mainframe 30. As such, pull collection system 72 queries or “pings” the pull portion of the plurality of suppliers 12 requesting flight information for a particular flight number. The queried supplier responds by sending a flight information message containing the flight information requested to pull collection system 72 via network communication link 15.

Push and pull collection systems 70 and 72 are each connected to authentication and validation system 74 by communication links 80 and 82, respectively. In one embodiment, push and pull collections systems 70 and 72 form one subsystem that is connected to authentication and validation system 74 by a single communication link. Authentication and validation system 74 compares the messages received by push and pull collection systems 70 and 72 for each supplier with the information contained in the corresponding supplier profile. In one embodiment, the data in each supplier profile stored in supplier profile database 76 includes one or more of a customer identification, a list of message types and/or formats that the supplier 12 is capable of sending, a supplier status (such as active, inactive, or suspended), a minimum security requirement, a collection method (such as push or pull), and other information useful in collecting and tracking the flight information.

In one embodiment, each flight information message collected contains a supplier identification block. Collection authentication and validation system 74 is capable of comparing the supplier identification block with supplier profile database 76 to determine whether each supplier 12 is a valid and active supplier capable of sending flight information in the message type and format received and whether the message possesses the minimum security requirements. In addition, authentication and validation system 74 is connected to error processing system 46 and is capable of reporting suppliers that are not valid, or active, or capable of sending the message type to error processing system 46. In one embodiment, authentication and validation system 74 is capable of validating the syntax and content of the flight information received.

Translator 78 is connected to authentication and validation system 74 and accepts flight information that has been successfully authenticated and validated. In one embodiment, translator 78 is capable of receiving flight information messages in a plurality of formats and identifying the format of each flight information message. Translator 78 is capable of translating each flight information message into a predefined common format. In one embodiment, the common format is an XML format. Translator 78 is capable of disseminating flight information from translated flight information messages for storage in storage system 42.

Storage System

In one embodiment, storage system 42 includes an active flight repository 90 and a historical flight repository 92. Active flight repository is coupled to historical flight repository 92 via communication link 94. Active flight repository 90 is capable of receiving flight information from collection system 40. Flight information is stored in active flight repository for comparison and access for distribution. In one embodiment, storage system 42 is capable of transferring flight information initially stored in active flight repository 90 to historical flight repository 92 after it has been stored in active flight repository 90 for a specified time period. The specified time period may be a predefined length of time or, alternatively, may be the time required to complete a specific transaction. In one embodiment, flight information remains in active flight repository 90 until it is sent to distribution system 44. As such, entries in active flight repository 90 can be compared to entries in historical flight repository 92 to determine if there has been a change to any portion of the flight information stored in storage system 42.

Distribution System

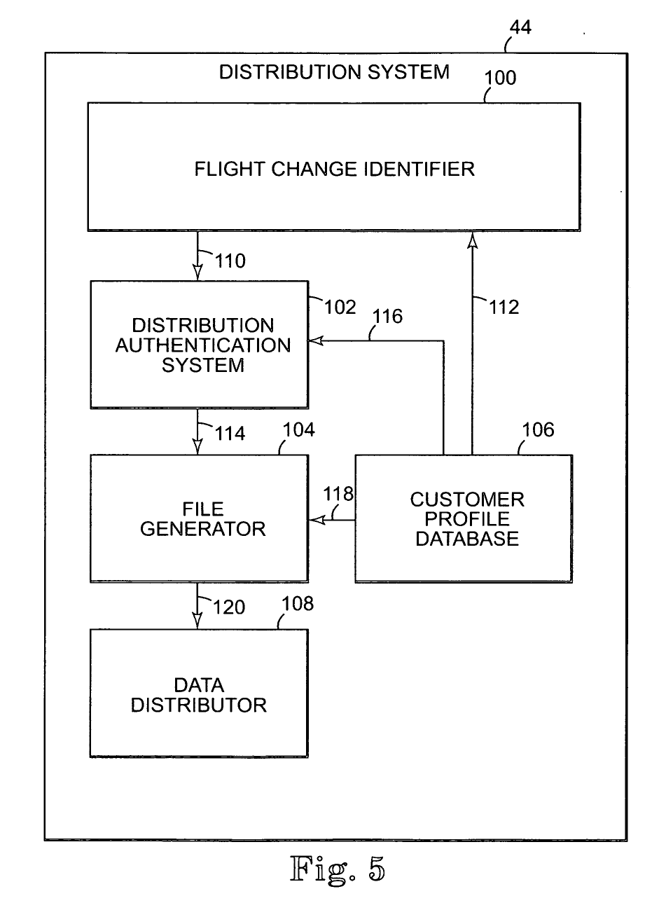

One embodiment of distribution system 44 is generally illustrated in FIG. 5. Distribution system 44 includes a flight change identifier 100, a distribution authentication and validation system 102, a file generator 104, a customer profile database 106, and a data distributor 108. Flight change identifier 100 is coupled to authentication and validation system 102 via communication link 110 and to customer profile database 106 via communication link 112. Authentication and validation system 198 is coupled to file generator 104 via communication link 114 and to customer profile database 106 via communication link 116. File generator 104 is coupled to customer profile database 106 via communication link 118 and data distributor 108 via communication link 120.

Flight change identifier 100 is capable of interacting with storage system 42 to identify flight information that has changed and forwards changed flight information to authentication and validation system 102, which is capable of identifying any of the plurality of customers 14 that have requested updated information for the flights for which changes have been identified by utilizing the information in customer profile database 106. In one embodiment, authentication and validation system 74 is also capable of verifying that each of the plurality of customers 14 identified is authentic. File generator 104 is capable of receiving information that has been verified and matching verified information to at least one of the plurality of customers 14. File generator 104 is further capable of generating a file for each of the requesting customers 14 in the format specified in the portion of customer profile database 106 corresponding to the particular customer 14. In one embodiment, the files generated are configured for distribution as e-mail or mobile messages. Data distributor 108 is capable of sending generated files to the corresponding plurality of customers 14. In one embodiment, data distributor 108 sends generated files to an electronic device, such as a computer; a wireless mobile device, such as a mobile phone, a PDA, or other wireless handheld device (e.g., a BlackBerry® device or an XDA device); or other electronic device accessible by the respective customer 14.

Flight change identifier 100 is capable of comparing data in active flight repository 90 and customer profile database 106 to match flagged changes to specific customer profiles that include requests for flight information corresponding to one or more of the flights flagged with a status change. In one embodiment, customer profile fields include one or more of the following: preferred format, request type and scope, time for delay, tolerance (the number of minutes delayed that constitutes a delay in the view of the particular customer), etc. In one embodiment, one or more of the following fields of the flagged changes are checked against customer profiles: departure time, arrival time, delay, gate, terminal, baggage claim, cancellations, and diversions. Flight change identifier 100 is capable of sending flagged changes matching one of the plurality of customers 14 requests together with identification of the particular customer 14 to be formatted into particularized status messages or files for each of the plurality of customers 14 identified.

Flight change identifier 100 is connected to authentication and validation system 74, which is capable of verifying that each of the identified plurality of customers 14 is active and non-suspended. In one embodiment, a customer will be active and non-suspended if the corresponding customer profile database 106 is properly completed and the customer 14 is current on payments for the requested service(s).

Authentication and validation system 74 is connected to file generator 104. File generator 104 is capable of accepting information from flight change identifier 100 and from customer profile database 106 to generate a file containing the flight information requested in the particular format requested for each of the plurality of customers. In one embodiment, file generator 104 is capable of generating files in a single common format to be sent to customers 14. In another embodiment, file generator 104 is capable of generating each file in the format specified in the corresponding customer profile where different customer profiles request flight information in different formats.

File generator 104 is connected to data distributor 108 and is capable of sending generated files to corresponding customers 14. In one embodiment, data distributor 108 is also connected to tracking system 46 and sends records of data or information distributed to tracking system 46. In one embodiment, data distributor 108 is connected to error processing system 48 and is capable of sending a record of any errors or problems in distribution to error processing system 48 for processing.

In one embodiment, distribution system 44 includes customer profile manager 107. Customer profile database 106 is capable of providing an interface for each of the plurality of customers 14 to interact with customer profile database 106 to verify, add, or change entries. In one embodiment, customer profile 106 is capable of being updated by the plurality of customers 14 via network communication link 16 or through customer interfaces. In one embodiment, customer profile database 106 includes a security system, which allows only authorized users to access certain entries within a customer profile. In one embodiment, some entries within a customer profile are only accessed by authorized employee(s) for FIMS 10.

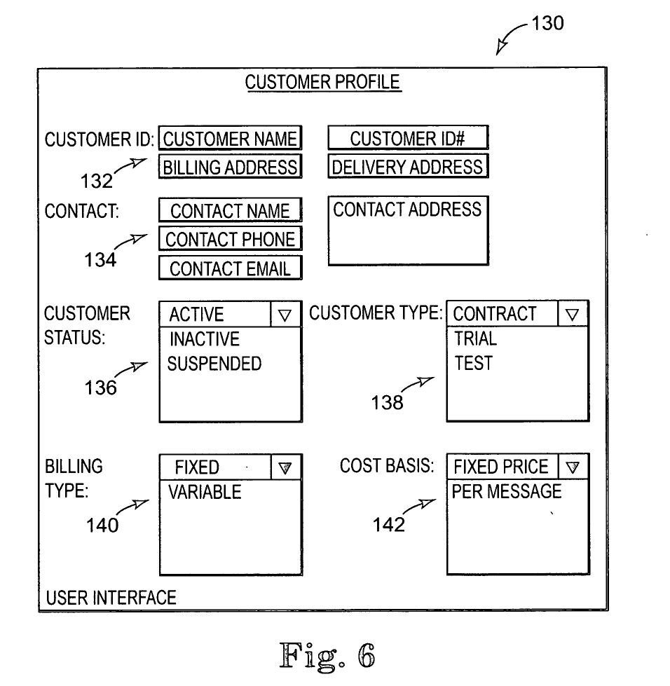

One embodiment of a customer interface to a customer profile is illustrated in FIG. 6 generally at 130. Customer interface 130 includes one or more of a customer identification input field 132, a contact input field 134, a customer status input field 136, a customer type input field 132, a billing type input field 140, and a cost basis input field 142. Input fields 132-142 define how, when, and in what format flight status messages should be sent to each of the plurality of customers 14. In one embodiment, only authorized individuals who successfully pass through a security check can access at least a portion of the input fields of customer interface 130. In one embodiment, customer interface 130 is accessed by customer 14 via an electronic device, such as a computer, a mobile phone, a PDA, a wireless handheld device (e.g. a BlackBerry® device or an XDA device), etc.

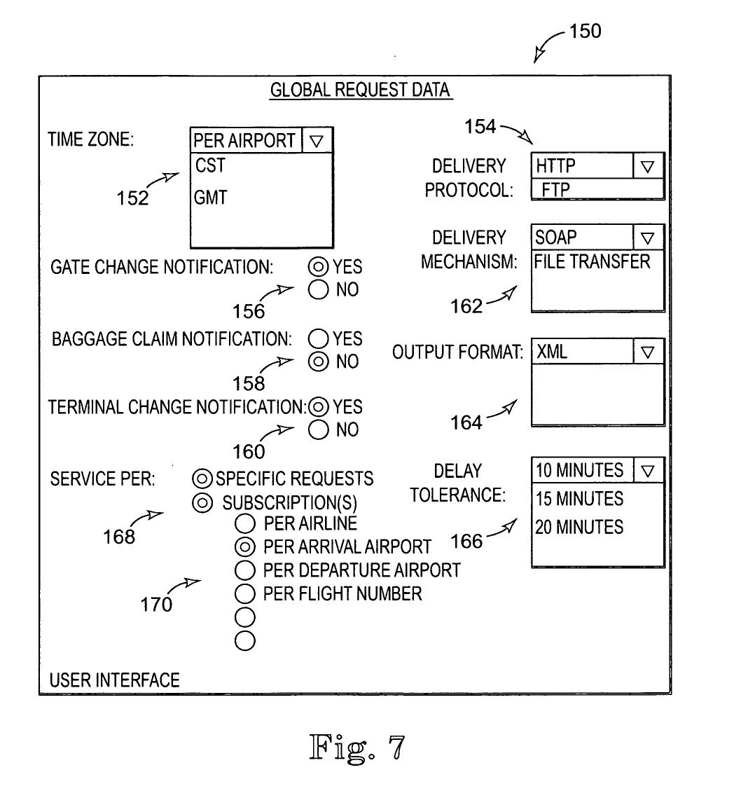

In one embodiment, each customer profile includes a global request data entry collection, an exemplary interface to which is generally illustrated at 150 in FIG. 7. Authorized personnel of FIMS 10 and authorized personnel of the plurality of customers 14 can access global request interface 150. Global requests interface 150 defines format and content of all messages sent to the particular customer. In one embodiment global request interface 150 includes one or more of a time zone input field 152, a delivery protocol input field 154, a gate change notification input field 156, a baggage claim notification input field 158, a terminal change input field 160, a delivery mechanism input field 162, an output format input field 164, a delay tolerance input field 166, a service description input field 168, and a plurality of service type input fields 170.

Service description input field 168 describes the type of FIMS 10 service that a customer has contracted with FIMS 10 to receive. Input field 168 includes specific request service and subscription service options for the customer to contract to receive. Specific request service allows a customer to make limited queries regarding flight information for certain flights or group of certain flights for a limited time period. In one embodiment, FIMS 10 bills each customer with service including specific requests on a per request or a per notification file sent basis. Subscription service provides ongoing flight information notification to a customer for all flights which fit the criteria of the subscription. In one embodiment, subscriptions are available based upon at least one of the following criteria: per airline, per arrival airport, per departure airport, and per flight number.

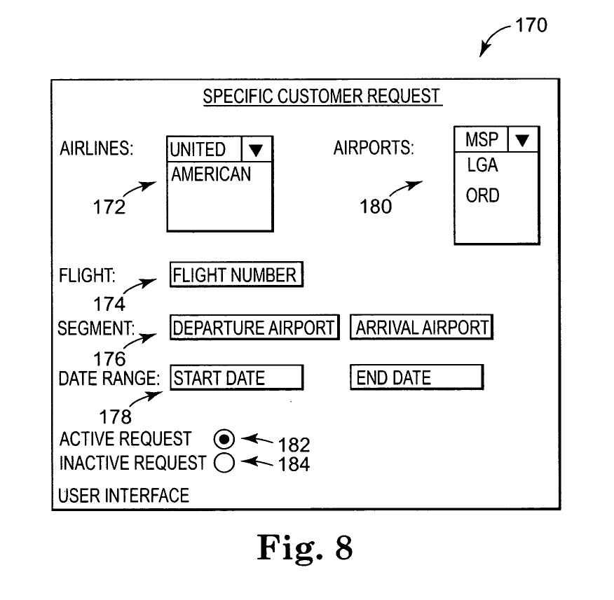

FIG. 8 illustrates an exemplary customer interface to enter specific customer requests generally at 170. Specific requests designate desired flight information separate from flight information collected on a subscription basis. Flight information requested on a subscription basis is identified based upon specification for the selected subscription service and is paid for on a subscription rather than per request basis. Specific request interface 170 includes an airline input field 172, a flight number input field 174, a segment input field 176, a date range input field 178, an airport input field 180, a stop flag 182, and a start flag 184. Input fields 172-180 identify the flight or flights for which information is requested. Flags 182 and 184 specify whether or not the specific request is currently active, i.e. whether information is currently requested for the identified flight of flights. More particularly, start flag 182 indicates the request is currently active. Conversely, stop flag 184 indicates the request is not currently active.

Error Processing System

Error processing system 48 is capable of receiving records of errors detected by collection system 40 and/or distribution system 44. As illustrated in FIG. 3, one embodiment of error processing system 48 includes an error log 190 and an error processor 192. Error log 190 is coupled to error processor 192 via communication link 94. Records of errors are temporarily stored to error log 190. Error log 190 is connected to and accessed by error processor 192. Error processor 192 is capable of analyzing errors from error log 190 in an attempt to determine the cause of the error and in attempt to correct the cause of the error to prevent future errors. In one embodiment, error processor 192 is capable of correcting at least one of a security error, a programming error, a supplier error, and a customer error. In one embodiment, error processor 192 is capable of analyzing errors by utilizing at least one of error analyzing computer programs and human error analysts or troubleshooters. In one embodiment, error processor 192 is capable of communicating with customer 14 or supplier 12 to determine and/or attempt to correct the cause of the error.

Tracking System

In one embodiment, tracking system 46 includes a transaction log 196 and a historical transaction database 198 coupled to transaction log 196 by a communication link 199. Tracking system 46 is capable of receiving records of transactions and/or error corrections and storing the records in a transaction log 196. Transaction log 196 is a database for storing transactional and error related records. In one embodiment, transaction log 196 is utilized to store only relatively new transaction and error records, and tracking system 46 further includes a historical transaction database 198 to store older transactions and error records. As such, tracking system 46 is capable of forwarding transaction records that have been stored in transaction log 196 for a specified amount of time to historical transaction database 198. Information stored in either transaction log 196 or historical transaction database 198 is accessible or can be forwarded to one or more of the plurality of customers 14 for analysis. In one embodiment, tracking system 46 is capable of forwarding transaction records to one or more of quality control system 32, market research system 34, and billings and accounting system 38 for analysis.

Method of Managing Flight Information

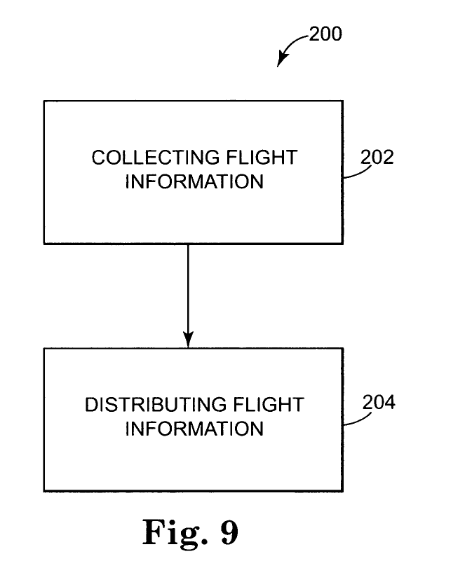

One embodiment of a method of managing flight information using FIMS 10 is generally illustrated at 200 in FIG. 9. Reference is also made to FIGS. 1 and 2. At step 202, flight information is collected from each of the plurality of suppliers 12, translated, and stored. In step 204, a portion of the stored flight information is accessed, matched with at least one of the plurality of customers 14, generated as a file, and distributed to the corresponding customer(s) 14. In one embodiment, a different file is generated for each of the plurality of customers 14. In one embodiment, a file is generated for a portion of the plurality of customers 14.

Collecting Flight Information

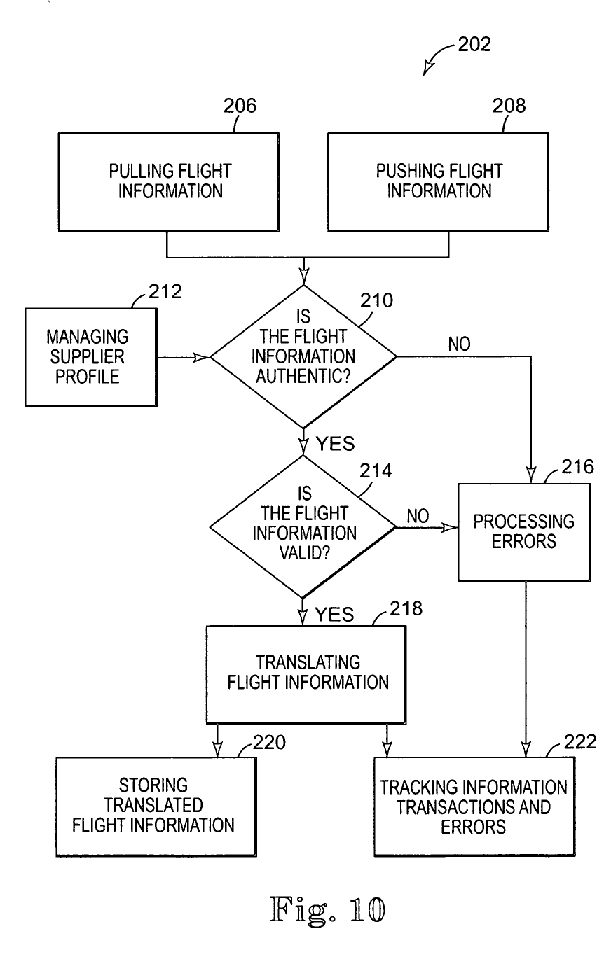

One embodiment of collecting flight information 202 is illustrated generally in FIG. 10. Reference is also made to FIGS. 1-5. At step 206, flight information is pulled from a portion of the plurality of suppliers 12 by pull collection system 72. At step 208, flight information messages are collected from a second portion of the plurality of suppliers 12 on a push basis by push collection system 70. In one embodiment, steps 206 and 208 occur substantially simultaneously. Each flight information message collected from the plurality of suppliers 12 in steps 206 and 208 is examined for authenticity by authentication and validation system 74 in step 210. The authenticity of the collected flight information message is based upon verification that the supplier sending the flight information message to FIMS 10 is authorized to supply flight information to FIMS 10. Authorization of a supplier 12 is based upon entries in supplier profile 76, which is managed by at least one of authorized supplier personnel or authorized personnel of FIMS 10 in step 212. If a flight information message is not authentic, an error is reported to error processing system 46.

In step 214, each flight information message is tested for validity. Flight information that is not valid is reported by authentication and validation sytem 74 to error processing system 46. In step 216, all errors reported to error processing system 46 in steps 210 and 214 are processed. A record of the error is sent to tracking system 48. Authenticated and validated flight information messages are translated into a common format in step 218. In step 220, flight information from the translated flight information messages is stored to storage system 42 and a transaction record of flight information collected is sent to tracking system 48. In step 222, error records and transaction records sent to tracking system 48 in steps 216 and 218 are stored in transaction log 196.

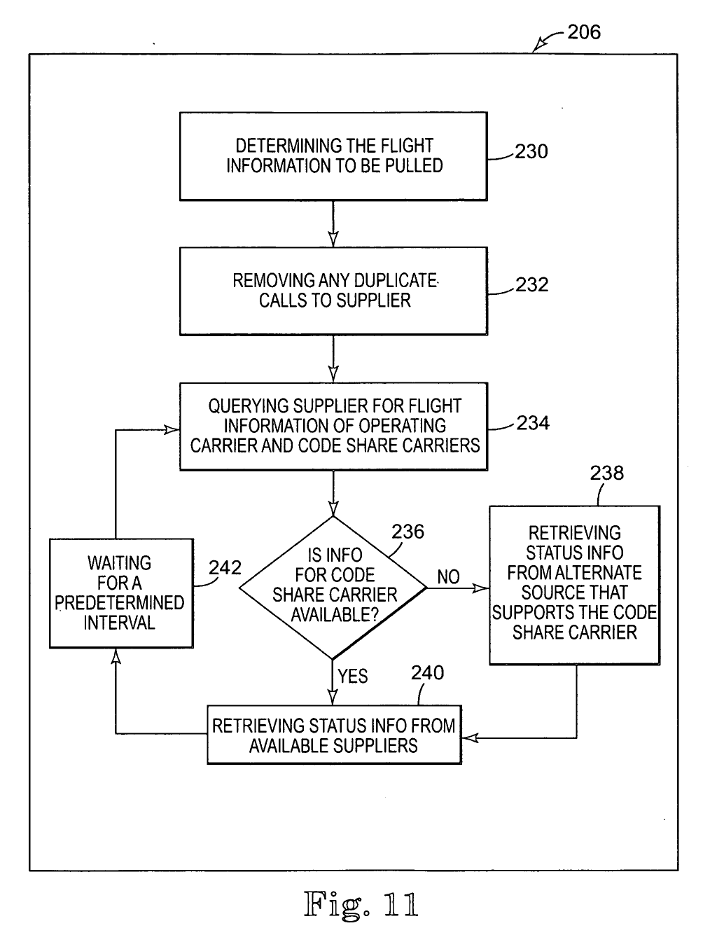

One embodiment of step 206, pulling flight information messages from a portion of the plurality of suppliers 12, is generally illustrated in FIG. 11. In step 230, the flight information to be pulled is determined by identifying the flight numbers required to be monitored via the pull process. In one embodiment, the flight numbers are determined by accessing schedule mainframe 30 to identify all flight numbers for the particular day for which information is to be collected. In one embodiment, identifying flight numbers includes retrieving code share carrier information relating to identified flight numbers. Code share carrier information is gathered for flights that are marketed by multiple airlines that share the same physical equipment operated by only one of the airlines for the particular flight. The flight numbers are compared against each supplier profile 76 to determine which suppliers 12 are capable of providing information on each flight number and if the corresponding supplier provides information on a push or pull basis.

Calls or queries regarding the flight numbers that correspond with the pull supplier are generated for each identified pull supplier. In one embodiment, the pull suppliers include one or more of pull airlines 22, pull GDS 26, air traffic control system 28, and schedule mainframe 30. In step 232, the queries are compared and any duplicate queries to a single pull supplier are removed. Removal of duplicate queries reduces unnecessary traffic over communication network 15 between FIMS 10 and the pull suppliers.

In step 234, the queries are sent out from FIMS 10 to the respective pull suppliers via communication network 15. In one embodiment, queries are sent to pull airlines 22 including operating carriers and code share carriers which correspond to the operating carrier for a particular flight. In one embodiment, multiple queries for a single supplier are batched together for more efficient transmission over communication network 15. In one embodiment, queries relate to and flight information is collected for one or more of passenger flights and cargo flights. In one embodiment, queries are sent to pull suppliers on a periodic basis. In one embodiment, queries are sent more frequently with respect to a particular flight the closer the query is in time to the departure or arrival of the particular flight. In one embodiment, queries regarding a particular flight are sent 240, 210, 190, 150, 120, 90, 60, 45, 30, 15, 10 and 5 minutes before the flights departure and 120, 90, 60, 45, 30, 15, 10 and 5 minutes before arrival.

In step 236, queries related to code share carriers sent via an operating or host pull airlines 22 are evaluated to determine if the flight information requested is available from the operating pull airlines 22. If the flight information requested is not available from the operating pull airlines 22, queries are sent to other pull suppliers to retrieve the flight information in step 238, such as pull GDS 20, air traffic control system 24, or schedule mainframe 26. In one embodiment, before additional queries are sent, responses to queries from pull suppliers already received are evaluated to determine whether they contain the desired flight information.

In step 240, flight information messages or responses to the queries of steps 234 and 238 are received from the suppliers 12. Following receipt of flight information messages in step 240, pull collection system waits for a predetermined interval in step 242. Following step 242, steps 234 through 240 are repeated. Steps 234-240 are continually repeated until a specified time after a particular flight has landed at the final arrival airport. In one embodiment, the predetermined interval of step 242 varies depending upon the time until a flight is scheduled for departure. In one embodiment, the predetermined interval is shorter the closer the time of query is to the departure time of the particular flight. Retrieved flight information is prepared for evaluation by authentication and validation system 102 of collection system 40.

In step 208 (shown in FIG. 10), flight information messages are collected from a portion of the plurality of suppliers 12 by a push method. The portion of the plurality of suppliers 12 to be collected from in step 208 includes the suppliers capable of pushing flight information to FIMS 10. These so-called push suppliers automatically send flight information messages upon addition, change, or cancellation relating to a flight number for which the supplier provides flight information. As such, push collection system 70 aggregates the flight information messages collected from the push suppliers. In one embodiment, step 206 and step 208 are performed substantially simultaneously.

Valid flight information messages are further evaluated in step 258 to determine if each respective supplier 12 is capable of sending flight information messages of the type or in the format in which the flight information messages were sent in to collection system 40.

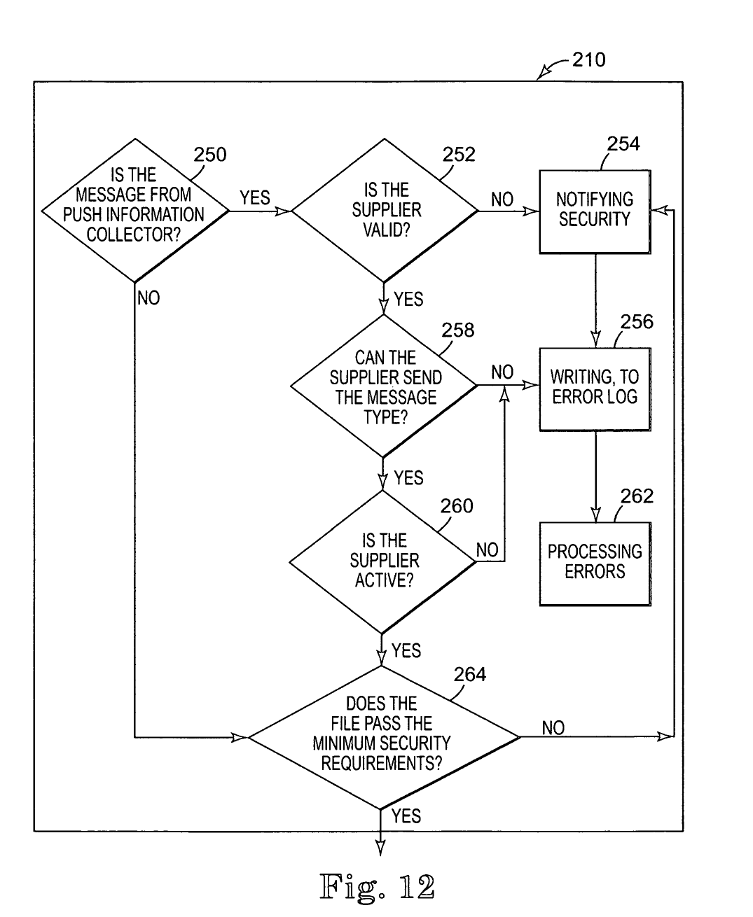

As generally illustrated in FIG. 12, in step 210 and more particularly in step 250, FIMS 10 determines if the flight information message being authenticated was collected by push collection system 70 or pull collection system 72. If the flight information message is from the push collection system 70, the flight information is evaluated to determine whether the supplier of the flight information is valid in step 252. The supplier is valid if the supplier identification, typically included in the flight information message, matches one of the suppliers identified supplier profile database 76. If a supplier is invalid, security is notified in step 254. Upon notification, security processes the error by contacting the supplier to work out the problem or other method of maintaining the integrity of FIMS 10 dictated by the type of security risk involved. An invalid customer further results in recording the finding to error log 190 in step 256.

In step 258, each flight information message received is compared to the supplier profile corresponding to the particular supplier 12 that sent the message being compared. If the format of the flight information message does not match one of the designated formats for the respective supplier 12, the message is written to error log 190 in step 256. If the format of the flight information message does match one of the designated formats for the respective supplier 12, authentication 210 continues.

The status of the supplier 12 of the flight information message is assessed in step 260. In step 260, the supplier is compared to the respective supplier profile to determine if the supplier is active, inactive, suspended, or some other status. Active suppliers are currently enabled and permitted to send flight information messages by FIMS 10. Conversely, inactive suppliers are not currently enabled and/or permitted to provide flight information messages to FIMS 10. Suspended suppliers are generally active suppliers without privileges to send flight information to FIMS 10 for a limited time or until the occurrence of a particular event. If the suppler is inactive or is suspended, the message is written to error log 190 in step 256. Notably, all errors written to the error log in step 256 are subsequently processed in step 262.

In step 264, pushed flight information messages from an active supplier and pulled flight information messages are examined to determine if each message passes the minimum security requirements of FIMS 10. In one embodiment, in order to pass the minimum security requirements, the message must be wrapped in a SOAP (Simple Object Access Protocol) envelope or better. If a message passes the minimum security requirements of step 264, the message can continue through collection step 202. If a message does not pass the minimum security requirements, it is reported to security in step 254 and written to error log 190 in step 256 for subsequent processing.

If the flight information message is not found to be authentic, the message is reported to error log 190 and processed in step 216. In step 216 and similarly in step 262 previously described errors are processed by error processor 198. In one embodiment, error processor 198 includes at least one of an employee of FIMS 10 or a processor of FIMS 10. In one embodiment, processing errors in step 216 includes at least one of determining the cause of each error, attempting to prevent similar future errors, generating reports highlighting errors and reasons, alerting FIMS 10 staff about internal problems, notifying supplier 12 of errors impacting message receivership, and re-synchronizing the system after system failure, if any.

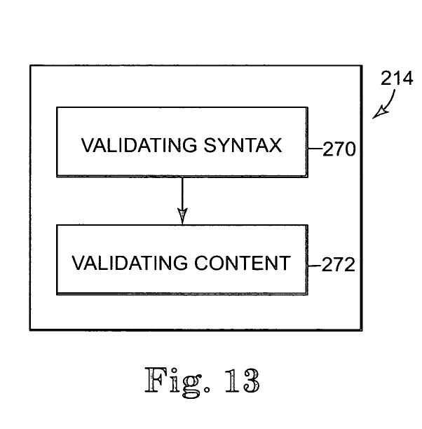

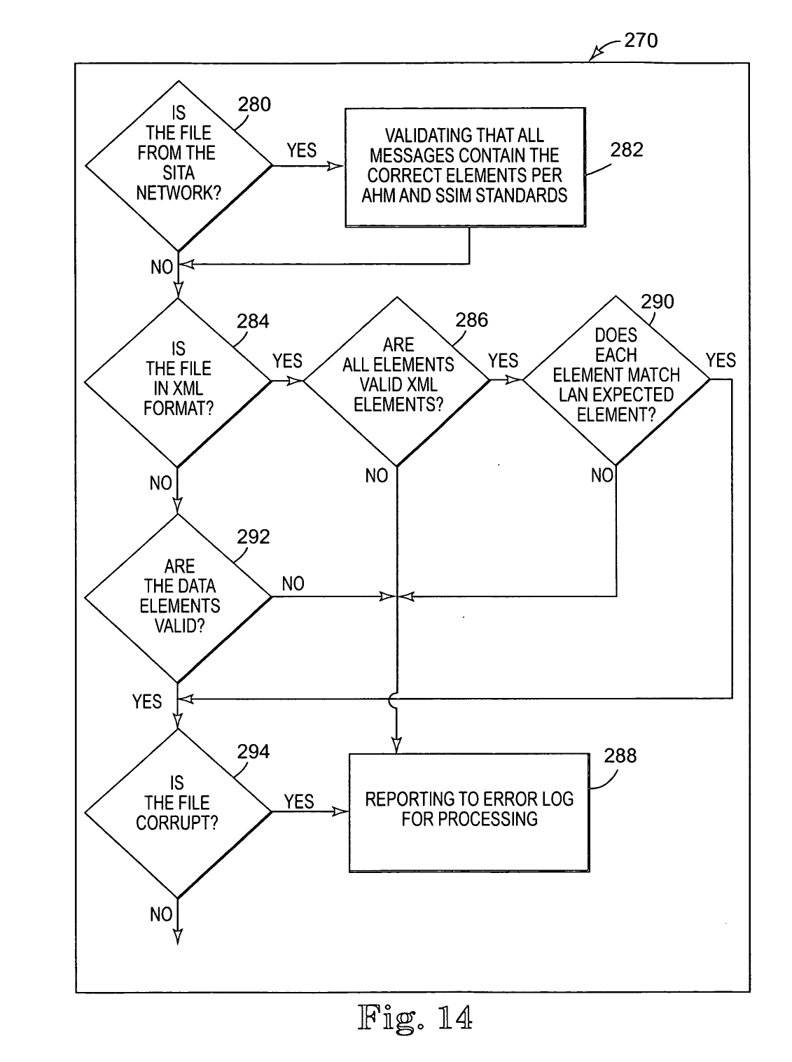

As generally illustrated in FIG. 13, the flight information messages are validated in step 214. Validation includes validating the syntax of the messages in step 270 and validating of the content of the messages in step 272. One embodiment of syntax validation 270 is generally illustrated in FIG. 14 and includes determining if the message was sent from the supplier 12 over SITA in step 270. If the flight information message was received by FIMS 10 via SITA, the message is evaluated to generally ensure that the messages contain the correct elements per the Airport Handling Manual (AHM) and the Standard Schedule Information Manual (SSIM) in step 282. Messages that do not conform to AHM and SSIM may be reported to error log 190 for subsequent processing as described with respect to step 216.

In step 284, the format of the flight messages sent via network communication link 15 other than SITA and flight messages sent via SITA containing the elements described above is determined. If the message is in XML format, the elements of the message are evaluated at step 286 to ensure that each element of the message is in valid XML format. In one embodiment, only messages collected by the pull process are checked for valid format to ensure against errors in the XML generation process of each supplier 12. If any element of the message is not in valid XML format, the message is reported to error log 190 for processing in step 288, similar to step 216. In step 290, each element of the message is also checked to determine if each element matches the type of element expected by FIMS 10. In one embodiment, the element expected by FIMS 10 are determined based on industry standards and will be defined by FIMS 10 prior to cultivation of a message sharing relationship with each of the plurality of suppliers 12. If the expected elements are not present, the message is reported to the error log for processing in step 288.

Messages not sent in XML format are evaluated in step 292 to determine if each data element contained therein is valid. If the flight message contains invalid data elements, it is reported to error log 190 for processing in step 288. In step 294, non-XML and XML messages are assessed to determine if the message is corrupt. In one embodiment, determining if the flight message is corrupt includes checking that the necessary start and end identifiers are present. Corrupt messages are reported to error log 190 for processing in step 288.

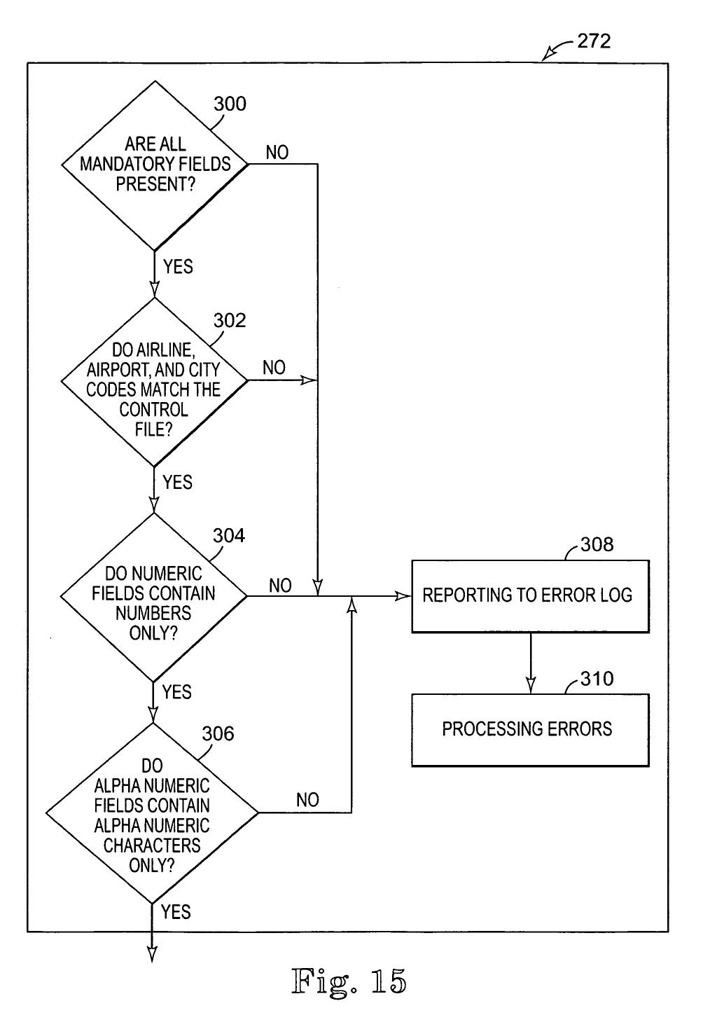

One embodiment of validating content in step 272, generally illustrated in FIG. 15, includes assessment of the flight message to determine if all mandatory content fields are present in step 300. In one embodiment, the mandatory content fields are defined by FIMS 10 and include one or more of the following: operating carrier, operating flight number, departure airport, arrival airport, scheduled departure time, scheduled arrival time, anticipated arrival time, anticipated departure time, terminal information, delay or cancellation reason code, date, time, etc.

In step 302, the flight information message is evaluated to determine if the airline, airport, and city codes match a control file originally obtained by airline 20 or 22 or schedule mainframe 30. In step 304, numeric fields within each flight information message are assessed to ensure that they contain only numeric entries. Similarly, in step 306, alpha numeric fields within each flight information message are assessed to ensure that they contain only alpha numeric entries. Any messages not properly validated in one of steps 300, 302, 304, and 306 are reported to error log 190 in step 308 for error processing in step 310 in a similar manner as described with respect to step 216.

In one embodiment, the fields evaluated in steps 304 and 306 include one or more of the following: operating carrier, operating flight number, departure airport, arrival airport, scheduled departure time, scheduled arrival time, anticipated arrival time, anticipated departure time, terminal information, delay or cancellation reason code, date, time, gate information, actual time plane left ground, actual time plane landed, diversion airport (if any), indicator if the leg has been cancelled, equipment type, aircraft registration, codeshare designator, re-clearance details, take-off fuel, take-off weight, number of passengers on board, date/time of next update for delay, etc.

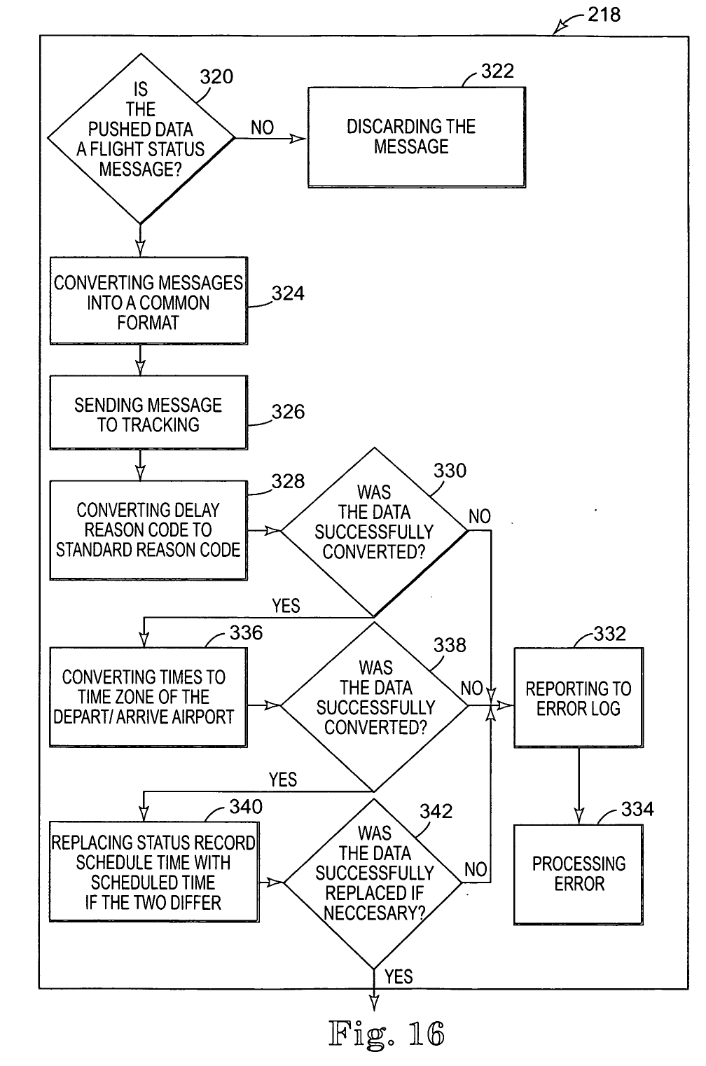

Flight information is translated by translator 78 in step 218, one embodiment of which is generally illustrated in FIG. 16. In step 320, the pushed message is evaluated to determine if it pertains to flight status. If the pushed message does not pertain to flight status, such as if the message pertains to a purchase of a plane, the message is discarded in step 322. In step 324, flight information messages are converted from a plurality of formats into a common format as defined by FIMS 10. In step 326, records of pushed messages that pertain to flight status and pulled messages are sent from translator 78 to tracking system 48.

In step 328, translator 78 converts the delay code of each flight message into a standard reason code determined by FIMS 10. In one embodiment, translator 78 utilizes a conversion chart or control table to convert individual airline codes into standard reason codes. If data conversion is not successful as evaluated in step 330, a record is sent to error log 190 in step 332 and processed in step 334 in a similar manner as described for step 216. In step 336, if required, the times (arrival, departure, etc.) included in each of the flight messages are converted to the time zone of the respective arrival and departure airports. Step 338 evaluates if the times are successfully converted. If the times are not found to be successfully converted, a record is sent to error log 190 in step 332 for processing in step 334.

In step 340, the schedule times included in the messages are compared to the scheduled time previously stored in active flight repository 90. The scheduled times refers to the original schedule and not the predicted actual times. If the schedule time of the message differs from the schedule time previously stored in active flight repository 90, the message scheduled time is replaced by the previously stored time. Step 342 evaluates if the replacement, if any, was successful. If the replacement was not successful, a record is sent to error log 190 in step 332 for processing in step 334. In one embodiment, a record of each replacement is sent to tracking system 48 for later evaluation by quality control 32.

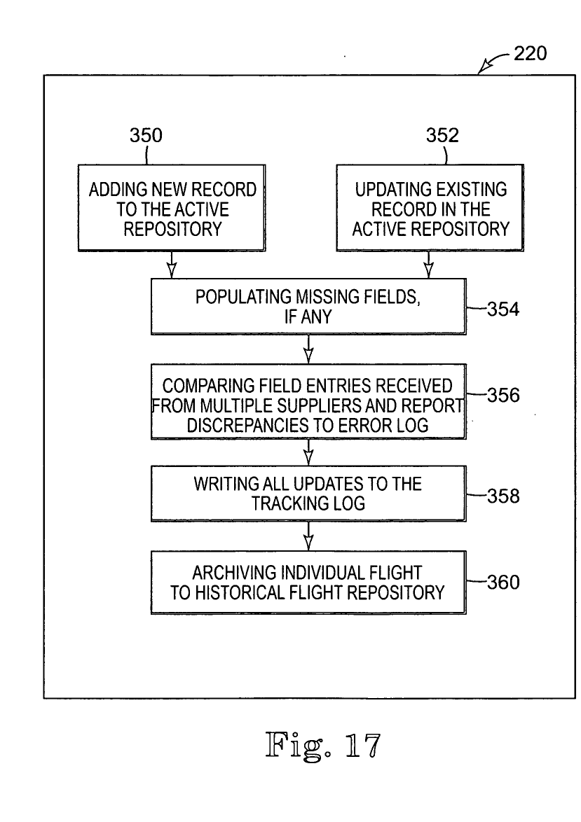

Information translated in step 218 is stored to storage system 42 in step 220. One embodiment of step 220 is generally illustrated in FIG. 17. New flight messages, i.e. flight messages pertaining to flight numbers that do not have previously stored entries in storage system 42, are stored to active flight repository 90 in step 350. In step 352, flight information updates to existing records stored in active flight repository 90 replace the pertinent fields of the existing records stored in active flight repository 90.

In step 354, any fields for a particular flight that are missing in active flight repository 90 are filled from other sources such as GDS 24 or 26, a code share carrier, or other alternative source 12. In step 356, the messages received from various suppliers concerning a single flight are compared to identify discrepancies, if any. If discrepancies are found, a record of the discrepancy is sent to error log 190 for evaluation in a manner similar to step 216. In one embodiment, step 354 includes identifying the relevant code share information for each flight and comparing common flight information for discrepancies.

In step 358, records of all updates and additions are sent to tracking system 48, and more particularly transaction log 196. In step 360, records stored in active flight repository 90 are transferred to historical flight repository 92. In one embodiment, step 360 occurs when updates to the flight information for the particular flight are unlikely to continue or when updates are no longer likely to be requested by one of the plurality of customers 14. In one embodiment, step 360 occurs 24 hours after the flight corresponding to the record to be transferred has landed.

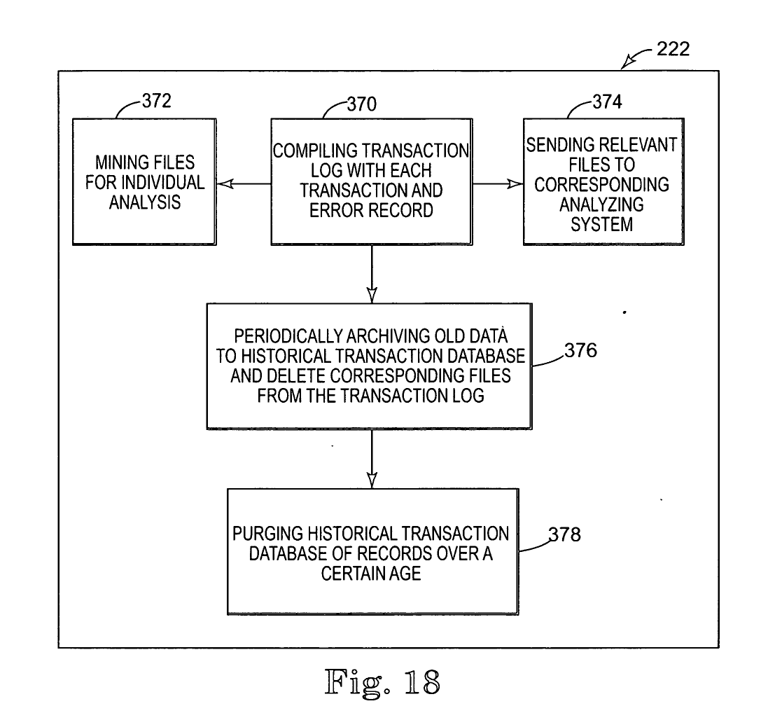

As generally illustrated in FIG. 18, message transactions between the plurality of sources 12 and FIMS 10 are tracked in step 222. In step 370, tracking database 48 is compiled to include records of each message transaction and/or each error record. In one embodiment, each record stored in tracking database 48 includes supplier identification and a date and/or time stamp. In step 372, FIMS 10 or one or more of the plurality of customers 14, such as quality control system 32 or market research system 34, mines transaction log 196 for specific information regarding transactions or errors in collecting (step 202) and/or distributing (step 204).

In step 374, relevant records stored in transaction log 196 are automatically sent to a corresponding analyst for analysis based upon predefined criteria from the analyst that identifies the records to be sent. In one embodiment, the corresponding analyst is one of the plurality of customers 14. In one embodiment, the corresponding analyst is one of quality control system 32, market research system 34, and accounting system 38. In one embodiment, the corresponding analyst is a system internal to FIMS 10.

In step 376, records previously stored in transaction log 196 are archived to historical transaction databases 96 and the corresponding transaction log 196 records are deleted. In one embodiment, records are archived on a periodic basis. In one embodiment, records are archived after a predefined time period has passed since the relevant flight has landed. However, archiving of transaction records may be based upon a number of other justifications. In step 378, historical transaction database 96 is purged of a record after a predefined period of storage of the record within historical transaction database 96.

Distributing Flight Information

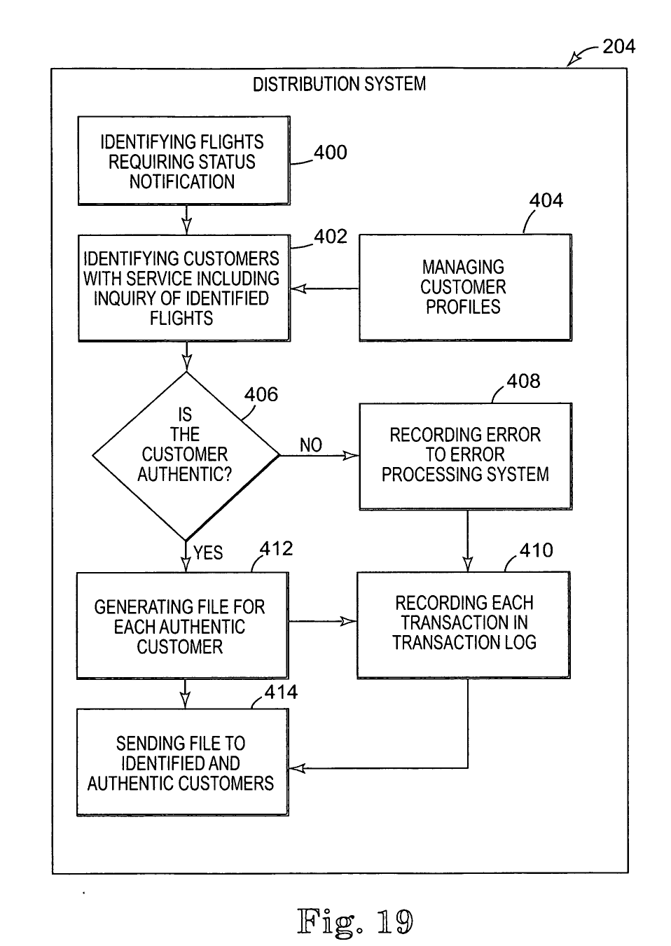

FIG. 19 generally illustrates one embodiment of distributing flight notification files from FIMS 10 to one or more of the plurality of customers 14 in step 204. In step 400, flight change identifier 100 identifies flights requiring notification of status change to one or more of the plurality of customers 14. In one embodiment, flights requiring status notification are identified in step 400 by comparison of prior messages sent to customers 14 regarding a particular flight and flight information regarding the particular flight stored in active flight repository 90. As such, flight change identifier 100 identifies flights that have undergone a status change since the last messages regarding the particular flight was sent. In one embodiment, identification of flights requiring status notification is effectuated by a status database (not shown) which tracks when updates are made to active flight repository 90 and when messages are sent to customers 14 by distribution. As such, flights in the status database that have been changed at a time subsequent to the latest status update distribution time require status notification.

In step 402, authentication system 102 identifies customers that have requested flight information concerning the flight of which flight status change was identified in step 400. Customers are identified by matching flights with status change to the customer profiles. If the identified flight falls within a customers subscription or matches a specific customer request of a particular customers, service of that customer includes inquiry about the particular flight. For all specific requests, the customer profile is checked to ensure exact match based on carrier, flight number, and date. In one embodiment, identifying customers with service including inquiry about a particular flight 402 further includes checking the particular customer profile to identify if the customer has requested the type of flight information that has undergone a status change. In one embodiment, gate, terminal, and baggage claim changes are only sent to customers 14 if a particular customer requested such status information in a corresponding customer profile. In one embodiment, status changes regarding time changes, diversions, and cancellations will always require customer notification.

The customers identified in step 402 are authenticated in step 404. Authentication of customers 14 includes determination of the customers status, i.e. whether the customer is active, inactive, suspended, etc. In one embodiment, a customer will only be notified of requested status changes if the customer is active. In one embodiment, a customer is deemed inactive or suspended if the customer has failed to pay for past services. If a customer is not authentic, an error record relating to authentication is sent to error processing system 46 for storage and processing in step 408. In one embodiment, any customer found to be unauthentic or any customer request that is unsuccessful is communicated to or sent back to the customer with a standard error code identifying the problem. In one embodiment, a record of authentication error is sent to tracking database in step 410.

In step 412, file generator 104 generates at least one notification file for each authentic customer with service including inquiry of the identified flight or flights. In one embodiment, the notification file contains at least one of the following information fields: carrier code, flight number, operating carrier code, operating carrier flight number, operational carrier data (SAD details such as aircraft owner, cockpit crew, cabin crew, onwards flight details, designator, etc.), equipment code, aircraft registration code, departure information, and arrival information.

In one embodiment, the notification file includes departure information such as one or more of the following: city code, airport code, scheduled terminal, estimated terminal, scheduled gate, estimated gate, scheduled departure date, estimated departure date, actual departure date, scheduled departure time, estimated departure time, actual departure time, estimated off block time, actual off block time, estimated airborne time, actual airborne time, delay reason codes, cancel indicator, etc. In one embodiment, the notification file includes arrival information such as one or more of the following: city code, airport code, scheduled terminal, estimated terminal, scheduled gate, estimated gate, scheduled arrival date, estimated arrival date, actual arrival date, scheduled arrival time, estimated arrival time, actual arrival time, estimated on block time, actual on block time, scheduled baggage claim, estimated baggage claim, estimated touchdown time, actual touchdown time, delay reason codes, diversion city code, diversion airport code, cancel indicator, etc.

In one embodiment, fields within a notification file that cannot be filled by the information in active flight database 90 are populated with the corresponding field in the original schedule data. In one embodiment, notification files are generated in various versions of the XML format. In one embodiment, notification files for different customers are generated in various formats. In one embodiment, notification files are generated for transfer as e-mail or mobile messages. Generated notification files are sent to the corresponding customer(s) in step 414. Generated notification files are also sent to transaction log 196 of tracking system 195.

In one embodiment, at least a portion of the records stored in transaction log 196 are also sent to a portion of the plurality of customers 14, such as quality control system 32, market research system 34, and billing and accounting system 38. In one embodiment, quality control system 32 sends pseudo customer requests to verify that FIMS 10 is functioning properly. In one embodiment, market research system 34 uses notification files to determine information regarding the airlines industry, such as on time rates per airline, airport, etc.

In one embodiment, billings and accounting system 38 uses the tracked information received to bill the other plurality of customers 14 per the agreement specified in the customer profile of each customer. In one embodiment, billings and accounting system 38 bills each customer or one or more of a fixed rate and a variable rate. The fixed rate typically relates to a subscription based FIMS 10 service, and a variable rate typically relates to FIMS 10 service based upon specific requests. In one embodiment, one or more of the plurality of customers 14 is located within FIMS 10.

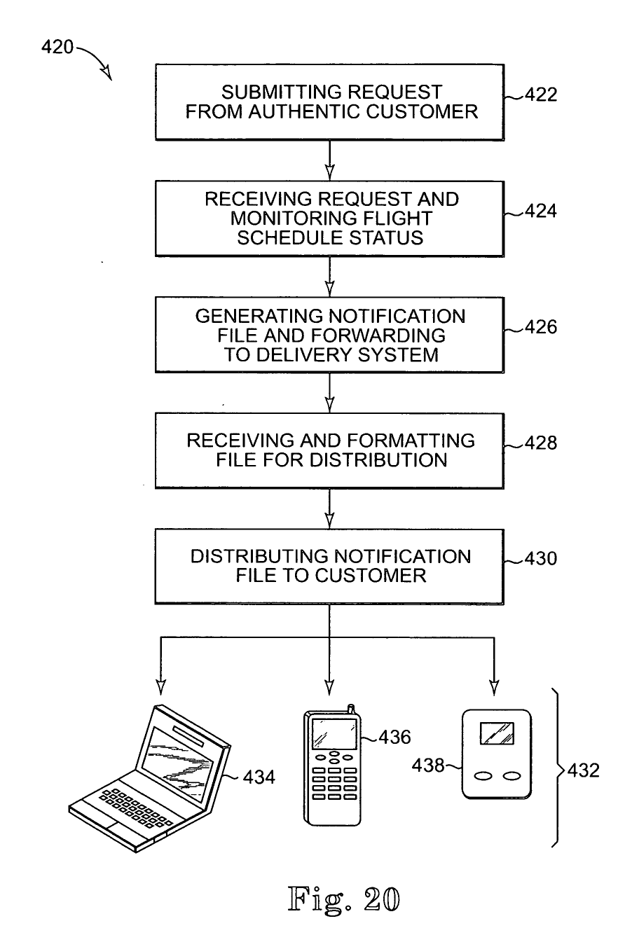

The flow chart of FIG. 20 illustrates one embodiment of a general request servicing process at 420. At 422, authentic customer 14 submits a request for flight status notification. The customer request may be subscription or specifically based as described above. In one embodiment, the customer request is submitted over an Internet-based system whether land based from a computer or wireless (e.g., a system utilizing Wireless Application Protocol, WAP) from a wireless mobile device, such as a mobile phone, a PDA, a wireless handheld device (e.g., a BlackBerry® device or an XDA device), accessible by customer 14.

At 424, FIMS 10 receives the initial customer request including which flight the customer specifies and begins to monitor the requested flight for schedule changes. In one embodiment, active monitoring or servicing of the specified flight begins a set time, such as four hours, before the schedule arrival or departure of the requested flight. In one embodiment, while monitoring the specified flight, FIMS 10 scans the storage system 42 for flight schedule changes on a periodic basis. More particularly, in one embodiment, FIMS 10 scans the storage system 42 for flight schedule changes every 15 minutes.

At 426, FIMS 10 identifies whether the specified flight requires notification and generates a notification file for forwarding to delivery system 17 (shown in FIG. 1). Notably, FIMS 10 monitors flight schedules and generates notification files in a similar manner as described above with respect to the collection system 202 and the distribution system 204. In one embodiment, at a set time, such as four hours before departure or arrival of the flight specified in the customer request, FIMS 10 generates an initial notification file to be sent to customer 14 indicating the current status of the flight and the fact that active monitoring of the flight has begun.

In one embodiment, FIMS 10 generates an additional notification file every time the specified flight is delayed beyond a given threshold time period. In one embodiment, the threshold time period is defined by the customer. In one embodiment, the threshold time period is defined by FIMS 10. In one embodiment, the threshold time period ranges from 1 to 60 minutes. In one embodiment, the threshold time period is 15 minutes. Upon generation of the notification file, the notification file is forwarded to delivery system 17 or alternatively is directly distributed to customer 14.

With this in mind, in one embodiment, in which the specified flight is on schedule throughout the monitoring period, customer 14 only receives the initial message at a set time, such as four hours, before the flight. In one embodiment, in which the specified flight is delayed at least one time beyond the threshold time period, a plurality of notification files are periodically distributed to customer 14, one each time the flight is additionally delayed beyond the threshold time period.

At 428, delivery system 17 receives the notification file from FIMS 10 and formats the notification file for distribution to customer 14. In one embodiment, delivery system 17 formats the notification file for wireless distribution to customer 14. More particularly, in one embodiment, delivery system 17 formats notification file for distribution to customer 14 as an e-mail or mobile message.

At 430, the notification file is distributed to customer 14 from delivery system 17 or, alternatively, directly from FIMS 10. In one embodiment, the notification file is forwarded to customer 14 via an electronic device 432, such as a computer 434 or a wireless mobile device, such as a mobile phone 436, a PDA, or other wireless handheld device (e.g., BlackBerry® device or XDA device) 438. In one embodiment, delivery system 17 routes the notification file for transfer via a specific wireless service provider (not shown) with access to customer 14.

With this in mind, upon notification of the current status of the flight specified in the customer request, customers 14 can adjust their travel, delivery, or other schedules to coincide with the actual departure and/or arrival of the specified flight(s).

In an alternative embodiment (not shown) delivery system 17 directly receives the request from customer 14 and services the request based upon database information received from FIMS 10. In particular, delivery system 17 includes a flight schedule database including flight schedule information periodically updated by FIMS 10. In such an embodiment, delivery system 17 performs at least a portion of distribution process 204. In one embodiment, delivery system 17 is an airlines or other travel based business that performs at least a portion of distribution process 204 with respect to at least a portion of customers 14.

FIMS 10 successfully collects and aggregates dissimilar flight information from a plurality of suppliers 12. Collection of flight information in different formats from a plurality of suppliers allows FIMS 10 to collect flight information for a relatively large percentage of all airline flights. Further, FIMS 10 actually stores flight information in storage system 42, thereby, allowing FIMS 10 to provide information to a plurality of customers 14 on either a specific request basis, a continuous basis, or a per changes basis. In addition, FIMS allows customers to tailor the flight information the customer is to receive through interaction with a dynamic customer profile. As such, FIMS 10 is able to provide customers access to a large percentage of flight status information on a relatively flexible request basis designed to serve the needs of each customer individually.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

1. A flight information system comprising:
a collection system including:
a collector for receiving flight information messages in a plurality of formats, and
a translator for converting flight information messages in the plurality of formats received by the data collector into flight information in a common format; and
a distribution system for selectively sending converted flight information to a customer as a mobile message.

2. The flight information system of claim 1, wherein the mobile message is an SMS message.

3. The flight information system of claim 1, wherein the distribution system selectively sends converted flight information to a customer via a wireless mobile device accessible by the customer.

4. The flight information system of claim 1, wherein the distribution system includes a file generator for generating a notification file containing a portion of the flight information as specified in a customer profile, the distribution system being configured to send the file generated by the file generator to the customer.

5. A distribution system for distributing flight information to a plurality of customers, the distribution system comprising:
a plurality of customer profiles, each customer profile storing a list of flight information requested by one of the plurality of customers;
a file generator for generating a notification file of flight information for each of the plurality of customers based upon the customer profile corresponding to each of the plurality of customers; and
a data distributor for selectively sending the notification files generated to the plurality of customers as mobile messages.

6. The distribution system of claim 5, wherein the mobile messages are SMS messages.

7. The distribution system of claim 5, wherein the data distributor sends the mobile messages to a plurality of wireless mobile devices accessible by the respective plurality of customers.

8. The distribution system of claim 5, wherein the data distributor includes a delivery system for converting notification files into mobile messages.

9. The distribution system of claim 5, wherein the data distributor includes a delivery system for routing the mobile messages to a wireless service provider having access to the customer.

10. A method of distributing flight information to a plurality of customers, the method comprising:
providing a customer profile for each of the plurality of customers;
identifying a change to flight information stored in a storage system;
generating a notification file for each of the plurality of customers based upon the change to the flight information and the customer profiles; and
selectively sending the notification files generated to the plurality of customers as mobile messages.

11. The method of claim 10, wherein the mobile messages are SMS messages.

12. The method of claim 10, wherein selectively sending the notification files includes selectively sending the notification files to an electronic device accessible by the respective customers.

13. The method of claim 12, wherein the electronic device is a wireless mobile device.

14. The method of claim 10, wherein selectively sending the notification files to the plurality of customers includes converting notification files to mobile messages.

15. The method of claim 10, wherein selectively sending the notification files to the plurality of customers includes routing the mobile messages to a wireless service provider having access to the customer.

16. The method of claim 10, wherein selectively sending the notification files to the plurality of customers includes selectively sending the notification files to a delivery system and forwarding the notification files to the plurality of customers from the delivery system.

17. A business method for providing flight information to a customer, the method comprising:
defining a customer profile including a financial model and a list of flight information requested by the customer under the financial model;
receiving flight information in a plurality of formats from a plurality of suppliers;
translating the flight information received in a plurality of formats to a common format;
distributing translated flight information to the customer based upon the customer profile as a mobile message;
tracking flight information distributed; and
billing the customer based upon the financial model and the flight information tracked.

18. The business method of claim 17, wherein the mobile message is an SMS message.

19. The business method of claim 17, wherein distributing translated flight information to the customer includes sending the mobile message to a wireless mobile device accessible by the customer.

20. The business method of claim 17, wherein distributing translated flight information to the customer includes forwarding translated flight information to a delivery system and distributing translated flight information to the customer from the delivery system.

21. The business method of claim 20, wherein the delivery system is an airlines.

22. The business method of claim 20, wherein the delivery system is a travel related business.

23. The business method of claim 17, wherein distributing translated flight information to the customer includes routing the mobile message through a wireless service provider with access to the customer.
